(19) United States
(12) Patent Application Publication
(10) Pub. No.: US 2022/0252901 A1
(43) Pub. Date: Aug. 11, 2022

(54) OPTICAL LENSES AND METHODS FOR MYOPIA CONTROL

(71) Applicant: University of Rochster, Rochester, NY (US)

(72) Inventor: Geunyoung Yoon, Houston, TX (US)

(21) Appl. No.: 17/595,719

(22) PCT Filed: Jul. 17, 2020
(86) PCT No.: PCT/US20/42488

§ 371 Date: Nov. 23, 2021

Related U.S. Application Data
(60) Provisional application No. 62/877,912, filed on Jul. 24, 2019.

(51) Int. Cl. G02C 7/02; G02C 7/04

(52) U.S. Cl. CPC G02C 7/027; G02C 2202/24; G02C 7/04

(57) ABSTRACT

A vision corrective lens for myopia control includes a myopia correction applied across the vision corrective lens. A plurality of additional peripheral aberrations is applied at more than about 20° eccentricity including at least an astigmatism correction, a defocus correction, and a spherical aberration correction, the combination of the plurality of additional peripheral aberrations to cause a radially symmetric blur pattern of a peripheral vision. A method to fabricate a myopia control device and a method to specify optical parameters of a myopia control device are also described.

### CROSS-REFERENCE TO RELATED APPLICATIONS

This application claims priority to and the benefit of co-pending U.S. provisional patent application Ser. No. 62/877,912, OPTICAL LENSES AND METHODS FOR MYOPIA CONTROL, filed Jul. 24, 2019, which application is incorporated herein by reference in its entirety.

### FIELD OF THE APPLICATION

The application relates to corrective lenses, particularly to corrective lenses for myopia control.

### BACKGROUND

The population of myopia patients has been booming worldwide. Although myopia can be easily corrected with optical and surgical interventions, pathological myopia is known to increase the risk of eye diseases such as cataracts, glaucoma and macular degeneration which cause large social economic burden worldwide. The genesis of myopia remains uncertain but is generally considered to have a multifactorial origin composed of optical, genetic and environmental factors.

### SUMMARY

A vision corrective lens for myopia control includes a myopia correction applied across the vision corrective lens. A plurality of additional peripheral aberrations is applied at more than about 20° eccentricity including at least an astigmatism correction, a defocus correction, and a spherical aberration correction, the combination of the plurality of additional peripheral aberrations to cause a radially symmetric blur pattern of a peripheral vision.

The plurality of additional peripheral aberrations can be corrections based at least in part on a measurement of at least one of: a peripheral astigmatism aberration, a peripheral defocus aberration, or a peripheral spherical aberration of an uncorrected eye.

An apodization function can be applied to the additional plurality of peripheral aberrations to reduce undesired changes to the myopia correction for a forward line of sight central vision at an eccentricity of about 10° or less.

The apodization function can include a gaussian apodization function.

The vision corrective lens can include a soft contact lens.

The vision corrective lens can include a hard contact lens.

The vision corrective lens can include a lens of eyeglasses.

The vision corrective lens can include a lens written through a surgical technique onto a cornea of an eye.

A method to fabricate a myopia control device includes: determining a myopia correction; determining a plurality of additional peripheral aberrations applied at more than about 20° eccentricity including at least an astigmatism correction, a defocus correction, and a spherical aberration correction, the combination of the plurality of additional peripheral aberrations to cause a radial symmetric blur pattern of a peripheral vision; combining the myopia correction and the plurality of additional peripheral aberrations; and forming the myopia control device with a combination of the myopia correction and the plurality of additional peripheral aberrations onto a surface of a corrective lens.

The method can further include after the step of determining the plurality of additional peripheral aberrations, applying an apodization function to the plurality of additional peripheral aberrations to provide an apodized plurality of the additional peripheral aberrations, and wherein the step of combining the myopia correction and the plurality of additional peripheral aberrations includes combining the myopia correction and the apodized plurality of the additional peripheral aberrations.

The step of forming can include forming the myopia control device onto the surface of the corrective lens by a machining technique.

The step of forming can include forming the myopia control device onto the surface of the corrective lens by a laser technique.

The step of forming can include forming the myopia control device onto the surface of a soft contact lens.

The step of forming can include forming the myopia control device onto the surface of a hard contact lens.

The step of forming can include forming the myopia control device onto the surface of a lens of eyeglasses.

The step of forming can include surgically forming the myopia control device onto the surface of a cornea of an eye.

A method to specify optical parameters of a myopia control device includes: determining a myopia correction; and adding a plurality of additional peripheral aberrations applied at more than about 20° eccentricity including at least an astigmatism correction, a defocus correction, and a spherical aberration correction, the combination of the plurality of additional peripheral aberrations to cause a radial symmetric blur pattern of a peripheral vision.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1A is a grid of images showing exemplary image focus quality across for the human visual field for a monofocal lens;

FIG. 1B is a grid of images showing exemplary image focus quality across for the human visual field for a dual focus lens;

FIG. 2B is a graph showing the Meridional effect (Banks, et al.);

FIG. 3A is a graph showing CS at 2 cpd;

FIG. 3B is a graph showing H:V CS Ratio;

FIG. 4 is a drawing showing an exemplary wide-field scanning ocular wavefront sensor;

FIG. 5A is an image and graph showing peripheral spherical refractive error temporal to nasal;

FIG. 5B is an image and graph showing peripheral spherical refractive error superior to inferior;

FIG. 5C is an image and graph showing peripheral spherical refractive error temporal superior to nasal inferior;

FIG. 5D is an image and graph showing peripheral spherical refractive error nasal superior to temporal inferior;

FIG. 6A is a graph showing peripheral aberrations of the human eye in vertical astigmatism;

FIG. 6B is another graph showing peripheral aberrations of the human eye in vertical astigmatism;

FIG. 6C is yet another a graph showing peripheral aberrations of the human eye in vertical astigmatism;

FIG. 6D is yet another graph showing peripheral aberrations of the human eye in vertical astigmatism;

FIG. 7A is a graph showing peripheral aberrations of the human eye in oblique astigmatism;

FIG. 7B is another graph showing peripheral aberrations of the human eye in oblique astigmatism;

FIG. 7C is yet another a graph showing peripheral aberrations of the human eye in oblique astigmatism;

FIG. 7D is yet another graph showing peripheral aberrations of the human eye in oblique astigmatism;

FIG. 8A is a graph showing peripheral aberrations of the human eye in vertical coma;

FIG. 8B is another graph showing peripheral aberrations of the human eye in vertical coma;

FIG. 8C is yet another a graph showing peripheral aberrations of the human eye in vertical coma;

FIG. 8D is yet another graph showing peripheral aberrations of the human eye in vertical coma;

FIG. 9A is a graph showing peripheral aberrations of the human eye in horizontal coma;

FIG. 9B is another graph showing peripheral aberrations of the human eye in horizontal coma;

FIG. 9C is yet another a graph showing peripheral aberrations of the human eye in horizontal coma;

FIG. 9D is yet another graph showing peripheral aberrations of the human eye in horizontal coma;

FIG. 10A is a graph showing peripheral aberrations of the human eye in spherical aberration;

FIG. 10B is another graph showing peripheral aberrations of the human eye in spherical aberration;

FIG. 10C is yet another a graph showing peripheral aberrations of the human eye in spherical aberration;

FIG. 10D is yet another graph showing peripheral aberrations of the human eye in spherical aberration;

FIG. 11 is a drawing showing how aberrations can be induced in local areas of a lens;

FIG. 12 is a drawing showing how defocus aberrations with X decentration can be induced in local areas of a lens;

FIG. 13 is a drawing showing how vertical astigmatism aberrations with X decentration can be induced in local areas of a lens;

FIG. 14 is a drawing showing how horizontal coma aberrations with X decentration can be induced in local areas of a lens;

FIG. 15 is a drawing showing how horizontal coma aberrations with Y decentration can be induced in local areas of a lens;

FIG. 16 is a drawing showing how spherical aberrations with X decentration can be induced in local areas of a lens;

FIG. 17 is a drawing showing how spherical aberrations with Y decentration can be induced in local areas of a lens;

FIG. 18A is a drawing showing how spherical aberrations with X decentration can be induced in a 4 mm local area of a lens;

FIG. 18B is a drawing showing how spherical aberrations with X decentration can be induced in a 6 mm local area of a lens;

FIG. 19 is a graph showing decentration of local area vs retinal eccentricity;

FIG. 20 is a plot showing an exemplary 8 mm diameter contact lens having the peripheral aberrations according to the example;

FIG. 21 is a series of images showing the point spread function without the lens.

FIG. 22 is the same series point spread images with the exemplary lens;

FIG. 23 shows convolved images without the lens;

FIG. 24 shows the convolved images for the lens of FIG. 20;

FIG. 25A shows a graphs of blur anisotropy with and without the exemplary lens of FIG. 20 at 0° eccentricity forward line of sight vision;

FIG. 25B shows a graphs of blur anisotropy with and without the exemplary lens of FIG. 20 at a 10° eccentricity;

FIG. 25C shows a graphs of blur anisotropy with and without the exemplary lens of FIG. 20 at a 20° eccentricity;

FIG. 25D shows a graphs of blur anisotropy with and without the exemplary lens of FIG. 20 at a 30° eccentricity;

FIG. 26A is a graph showing an exemplary apodization function;

FIG. 26B is a plot showing a lens with peripheral aberrations as described hereinabove;

FIG. 26C is a plot showing the lens of FIG. 26B with apodization using the exemplary function of FIG. 26A.

FIG. 27 is a series of images showing the point spread function without the lens of FIG. 26C;

FIG. 28 is the same series point spread images with the exemplary lens of FIG. 26C;

FIG. 29 shows convolved images without the lens;

FIG. 30 shows the convolved images for the lens of FIG. 26C;

FIG. 31A shows a graphs of blur anisotropy with and without the exemplary lens of FIG. 26C at 0° eccentricity forward line of sight vision where sigma is pupil/8;

FIG. 31B shows a graphs of blur anisotropy with and without the exemplary lens of FIG. 26C at a 10° eccentricity where sigma is pupil/8;

FIG. 31C shows a graphs of blur anisotropy with and without the exemplary lens of FIG. 26C at a 20° eccentricity where sigma is pupil/8;

FIG. 31D shows a graphs of blur anisotropy with and without the exemplary lens of FIG. 26C at a 30° eccentricity where sigma is pupil/8.

FIG. 32A shows a graphs of blur anisotropy with and without the exemplary lens of FIG. 26C at 0° eccentricity forward line of sight vision where sigma is pupil/12;

FIG. 32B shows a graphs of blur anisotropy with and without the exemplary lens of FIG. 26C at a 10° eccentricity where sigma is pupil/12;

FIG. 32C shows a graphs of blur anisotropy with and without the exemplary lens of FIG. 26C at a 20° eccentricity where sigma is pupil/12;

FIG. 32D shows a graphs of blur anisotropy with and without the exemplary lens of FIG. 26C at a 30° eccentricity where sigma is pupil/12;

### DETAILED DESCRIPTION

Myopia, or nearsightedness, may be associated with other progressive eye disorders such as retinal detachment and glaucoma that could lead to permanent blindness. Myopia can be corrected, so that an individual can have a corrected vision for some period of time until further correction is needed. However, mere correction of myopia may have no impact on other possibly related disorders.

It has been postulated by myself and my colleagues, such as in our publication, Through-focus optical characteristics of monofocal and bifocal soft contact lenses across the peripheral visual field Ji, Yoo, and Yoon, 24 Apr. 2018 https://doi.org/10.1111/opo.12452 that a mechanism underlying myopia control with these bifocal or multifocal contact lenses is an increase in depth of focus (DoF) and a decrease in anisotropy of peripheral optical blur.

Particularly for children and young adults where eye growth is still particularly active, it may be desirable when correcting myopia, to also modify the peripheral vision by intentionally introducing higher order aberrations in the peripheral vision. These higher order aberrations in the peripheral vision do not per se improve vision. Rather it is postulated that such aberrations may control growth of the eye, particularly in young people, which might minimize or possibly prevent the disorders commonly associated with myopia.

The primary goal of any corrective measure is to correct the person's vision to compensate for the myopia. Corrective measures include, for example, contact lenses, including soft contact lenses (SCL), hard contact lenses, eyeglasses, and surgical interventions, including writing lenses directly on the cornea of the eye. Hard contact lenses include, for example, rigid gas permeable, scleral lens (small and large diameter), and orthokeratology.

The new peripheral aberrations of the Application should be added to the myopia correction. A problem is now how to introduce the aberrations for peripheral vision along with the primary goal of the myopia correction. Another problem is how to keep the desired aberrations at the periphery from degrading the overall corrective effect of the first or higher order myopia correction. The new peripheral aberrations of the Application can be included in the corrective optical design of any suitable myopia correction device.

This Application presents solutions to both problems in several parts. Part 1 describes human neural anisotropy of the peripheral vision, the Meridional Effect, and observed natural human aberrations. Part 2 describes a solution where a combination of astigmatism, coma, and spherical aberration can be added to the myopia correction. Part 3 describes a solution to the problem of undesirable degradation of the myopia correction by apodization of the higher order peripheral aberrations.

Part 1 Human Neural Anisotropy of the Peripheral Vision, the Meridional Effect, and Observed Natural Human Aberrations

Uncorrected, or corrected (e.g. by monofocal or bifocal SCL), human vision typically provides an in-focus image near the center of vision of the eye and a blurred image towards the periphery of the eye. The center of vision is typically within about 10° of our line of sight (about 0° where the image is projected directly onto the fovea), the peripheral vision from an eccentricity of more than about 10° out to about 90° from the center forward line of sight.

The primary goal of the well-known first or higher order myopia correction is to provide an in-focus image in the forward line of sight. The peripheral vision and area of desired aberrations of the Application (for reasons other than the Myopia correction) is to introduce a radial symmetry in the peripheral vision and an eccentricity of generally between about 20° and 40°. The progression of myopia may be slowed by such peripheral aberrations.

As described hereinbelow in more detail, various aberrations according to the Application are now newly introduced to provide a more symmetric view of the peripheral blur orientation, such as through focus of the peripheral vision of the human eye.

The angle off the line of sight is referred to alternatively herein as retinal eccentricity of the peripheral retina which is understood to typically be cited in units of degrees off the line of sight relative to the fovea at 0°, which provides the center line of site in focus image.

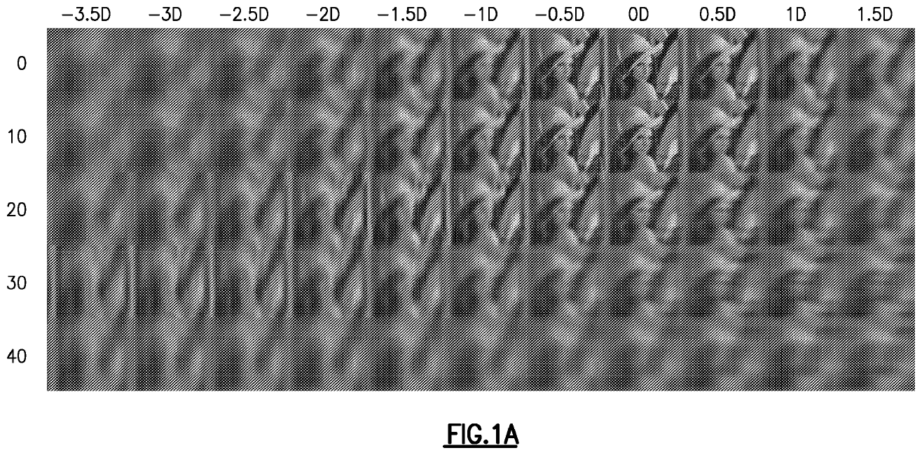

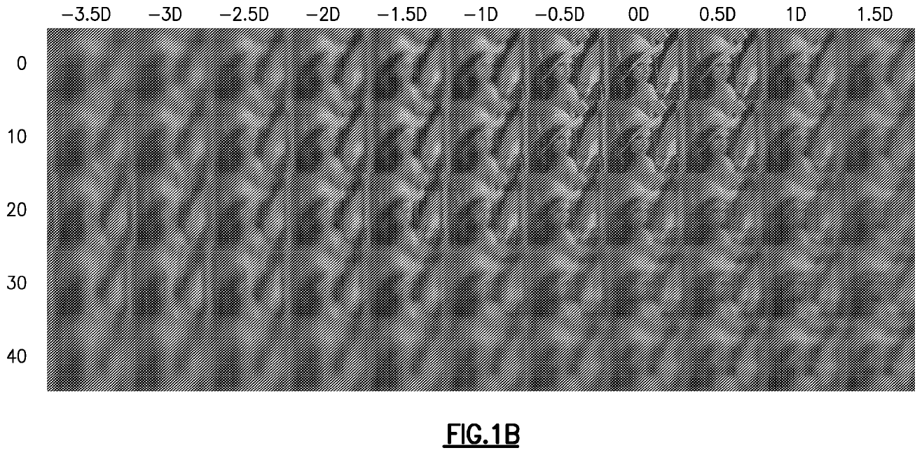

FIG. 1A and FIG. 1B shows images for various diopter (D) corrections versus angular deviation from the center of vision, where 0° is the center forward line of sight, and 40° approaches the furthermost peripheral vision, i.e. what we “see” out to the side, or from the corner of our eyes. FIG. 1A is a grid of images showing exemplary image focus quality across for the human visual field for a monofocal lens. FIG. 1B is a grid of images showing exemplary image focus quality across for the human visual field for a dual focus lens. In both cases, the blur at larger eccentricity, such as, for example at an eccentricity of 30°, rotates from a vertical orientation to a horizontal orientation.

FIG. 2A is an image of a retina showing how the human eye perceives grating lines, where according to the Meridional effect, the orientation of the perceived lines varies, for example, in FIG. 2A, from horizontal to vertical moving around the periphery of the retina, which represent the peripheral vision. At the meridian, there is a better performance at higher eccentricity for a viewed horizontal grating than for a viewed vertical grating, as compared with the central vision (fovea) where the performance of the human eye is the same for both the same horizontal and vertical gratings). FIG. 2B is a graph showing the Meridional effect (Banks, et al.).

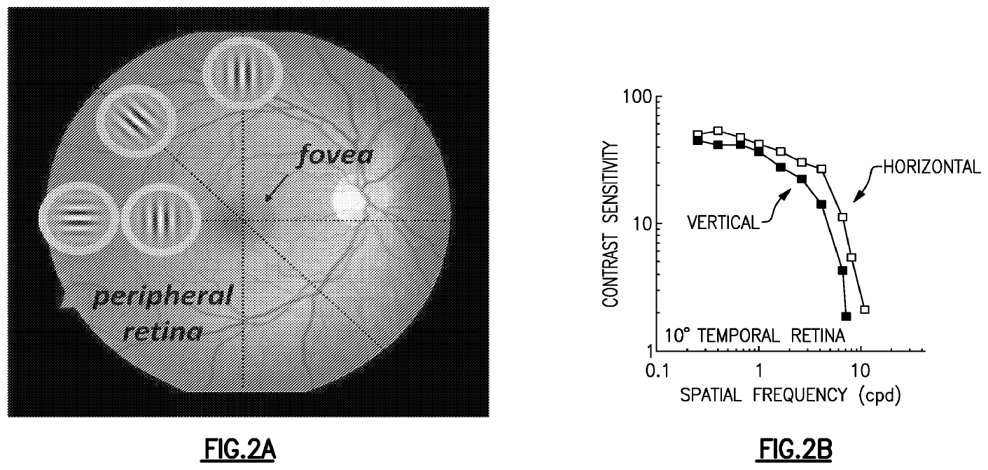

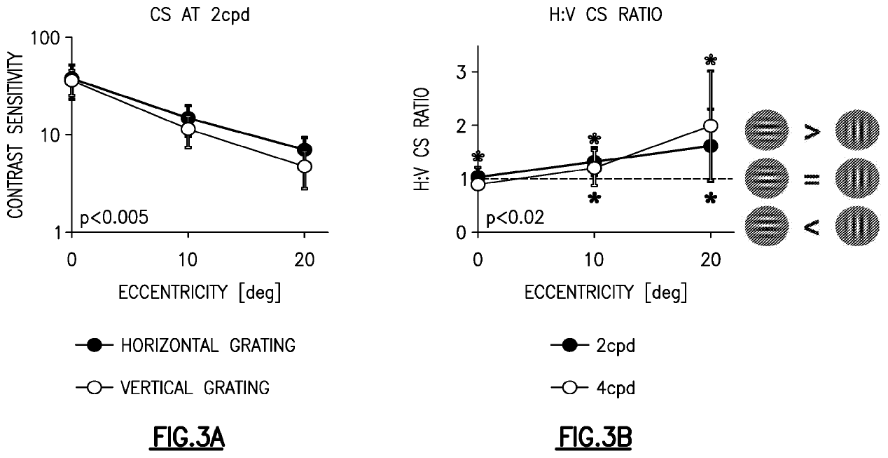

FIG. 3A and FIG. 3B are graphs showing the Meridional effect (Zheleznyak, et. Al.). FIG. 3A is a graph showing CS at 2 cpd. FIG. 3B is a graph showing H:V CS Ratio.

Typical peripheral aberrations of the human eye were measured. FIG. 4 is a drawing showing an exemplary wide-field scanning ocular wavefront sensor used to measure peripheral aberrations of the human eye. Blur anisotropy is caused by asymmetric aberrations at the periphery of the uncorrected eye (e.g. astigmatism and coma at the periphery). As described in more detail hereinbelow, the new structures correct these previously uncorrected natural peripheral asymmetric aberrations. The new corrections will make the point spread function (PSF) at the peripheral vision radially symmetric.

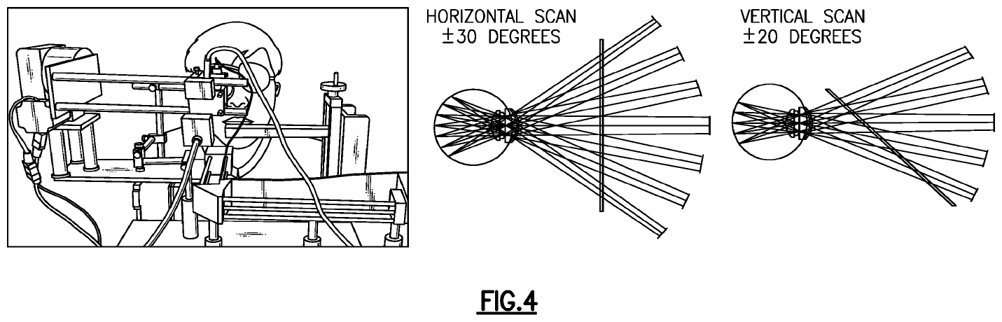

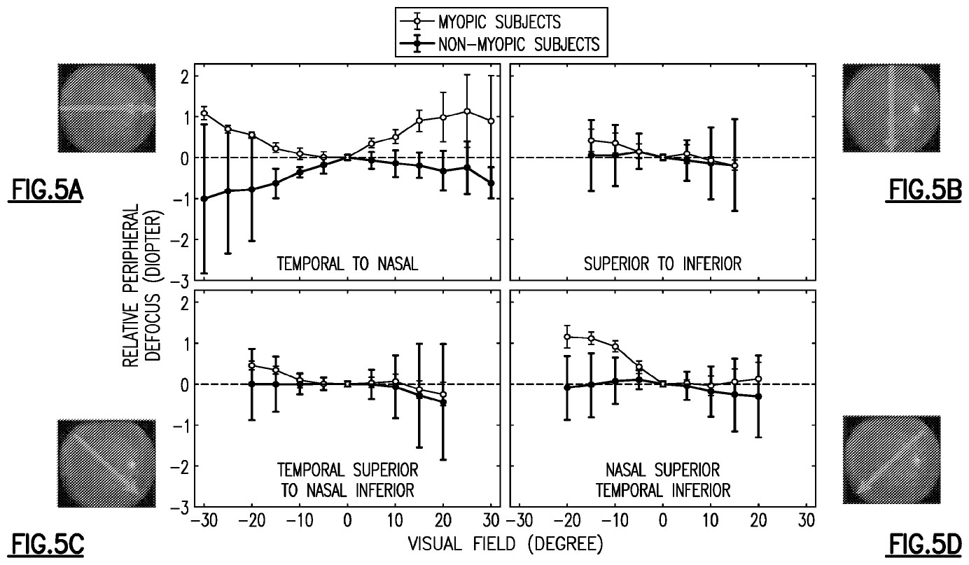

Beginning with uncorrected vision, FIG. 5A to FIG. 5B are images paired with plots of mean±SD of relative peripheral defocus for myopic and non-myopic subjects showing peripheral aberrations of the human eye in defocus (spherical refractive error). These measurements were made by use of a wide-field scanning ocular wavefront sensor. FIG. 5A is an image and graph showing peripheral spherical refractive error Horizontal meridian (temporal to nasal). FIG. 5B is an image and graph showing peripheral spherical refractive error vertical meridian (superior to inferior). FIG. 5C is an image and graph showing peripheral spherical refractive error 45° diagonal medial (temporal superior to nasal inferior). FIG. 5D is an image and graph showing peripheral spherical refractive error 135° diagonal medial (nasal superior to temporal inferior).

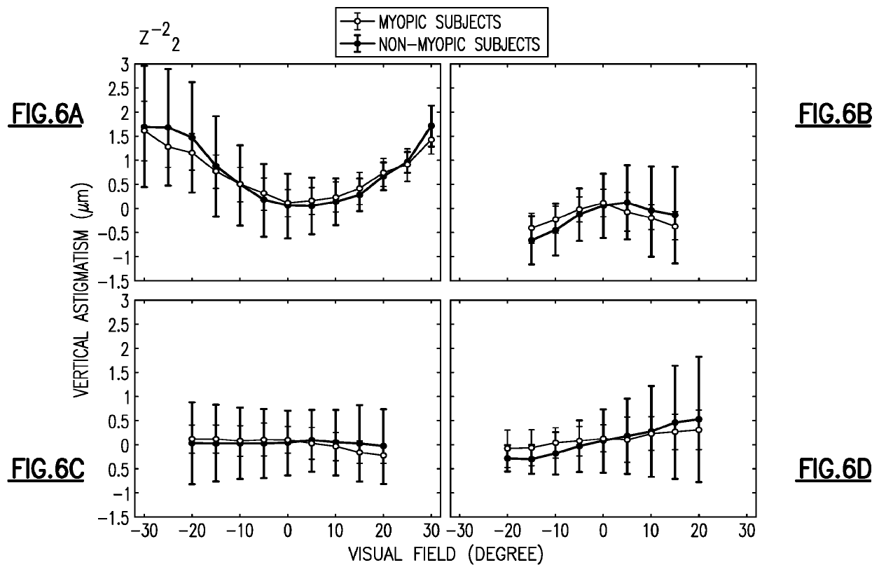

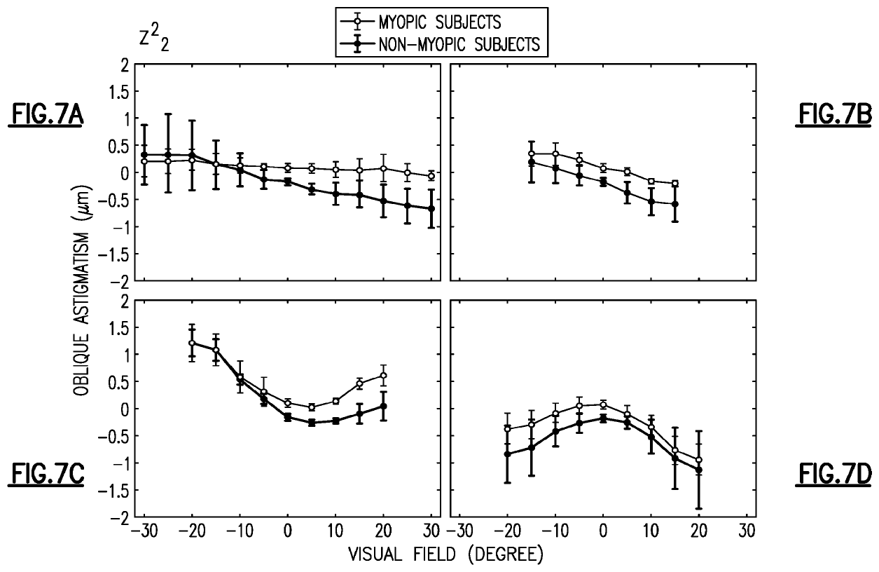

FIG. 6A to FIG. 7D are graphs showing peripheral aberrations of the human eye in vertical and oblique astigmatism for both myopic and non-myopic subjects. FIG. 6A is a graph showing peripheral aberrations of the human eye in vertical astigmatism. FIG. 6B is another graph showing peripheral aberrations of the human eye in vertical astigmatism. FIG. 6C is yet another a graph showing peripheral aberrations of the human eye in vertical astigmatism. FIG. 6D is yet another graph showing peripheral aberrations of the human eye in vertical astigmatism. FIG. 7A is a graph showing peripheral aberrations of the human eye in oblique astigmatism. FIG. 7B is another graph showing peripheral aberrations of the human eye in oblique astigmatism. FIG. 7C is yet another a graph showing peripheral aberrations of the human eye in oblique astigmatism. FIG. 7D is yet another graph showing peripheral aberrations of the human eye in oblique astigmatism.

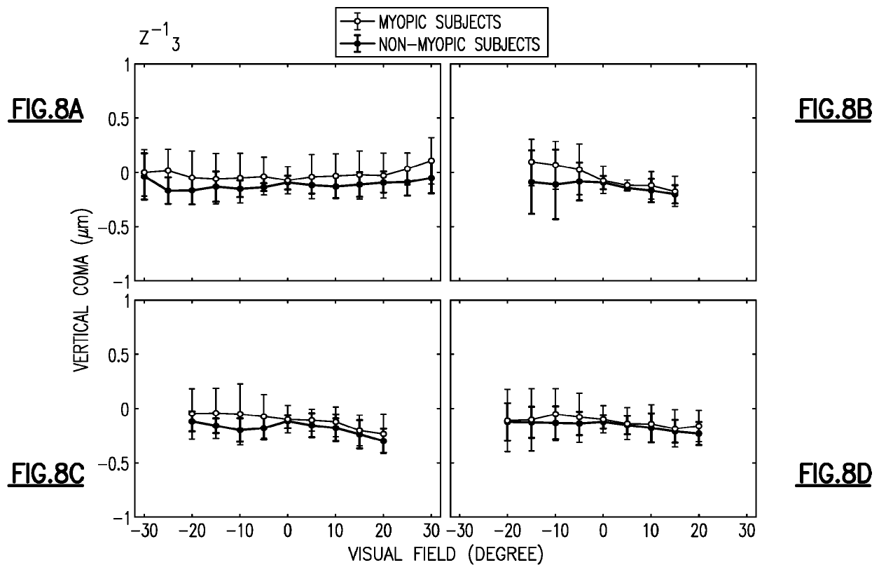

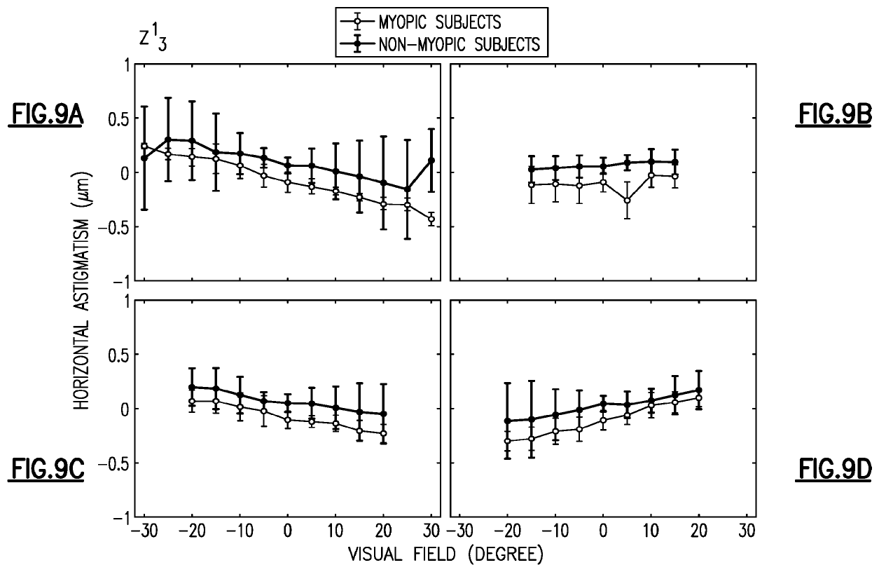

FIG. 8A to FIG. 9D are graphs showing peripheral aberrations of the human eye in vertical and horizontal coma for both myopic and non-myopic subjects. FIG. 8A is a graph showing peripheral aberrations of the human eye in vertical coma. FIG. 8B is another graph showing peripheral aberrations of the human eye in vertical coma. FIG. 8C is yet another a graph showing peripheral aberrations of the human eye in vertical coma. FIG. 8D is yet another graph showing peripheral aberrations of the human eye in vertical coma. FIG. 9A is a graph showing peripheral aberrations of the human eye in horizontal coma. FIG. 9B is another graph showing peripheral aberrations of the human eye in horizontal coma. FIG. 9C is yet another a graph showing peripheral aberrations of the human eye in horizontal coma. FIG. 9D is yet another graph showing peripheral aberrations of the human eye in horizontal coma.

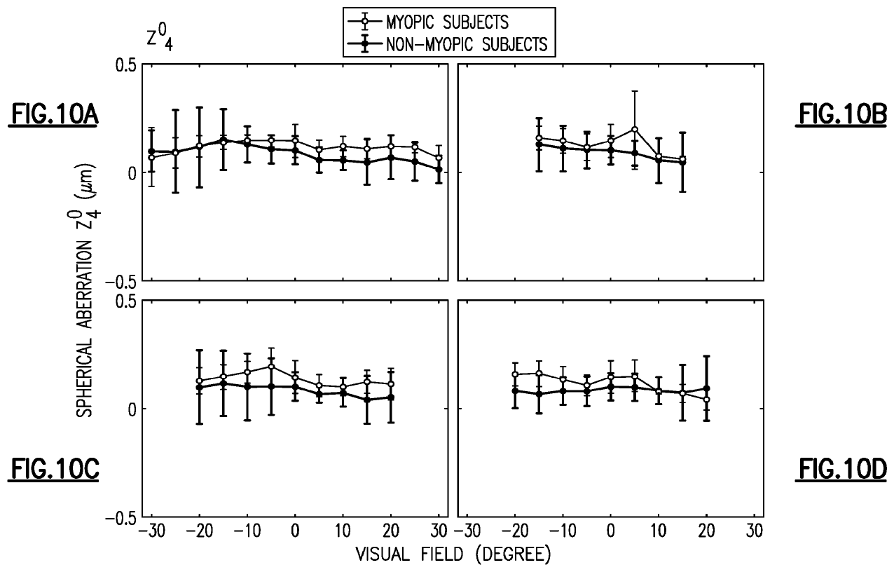

FIG. 10A to FIG. 10D are graphs showing peripheral aberrations of the human eye in spherical aberration for both myopic and non-myopic subjects. FIG. 10A is a graph showing peripheral aberrations of the human eye in spherical aberration. FIG. 10B is another graph showing peripheral aberrations of the human eye in spherical aberration. FIG. 10C is yet another a graph showing peripheral aberrations of the human eye in spherical aberration. FIG. 10D is yet another graph showing peripheral aberrations of the human eye in spherical aberration.

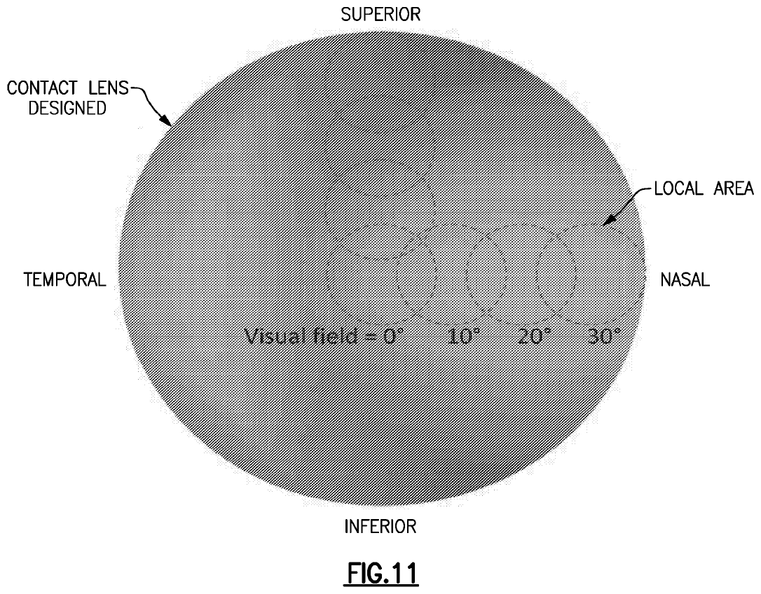

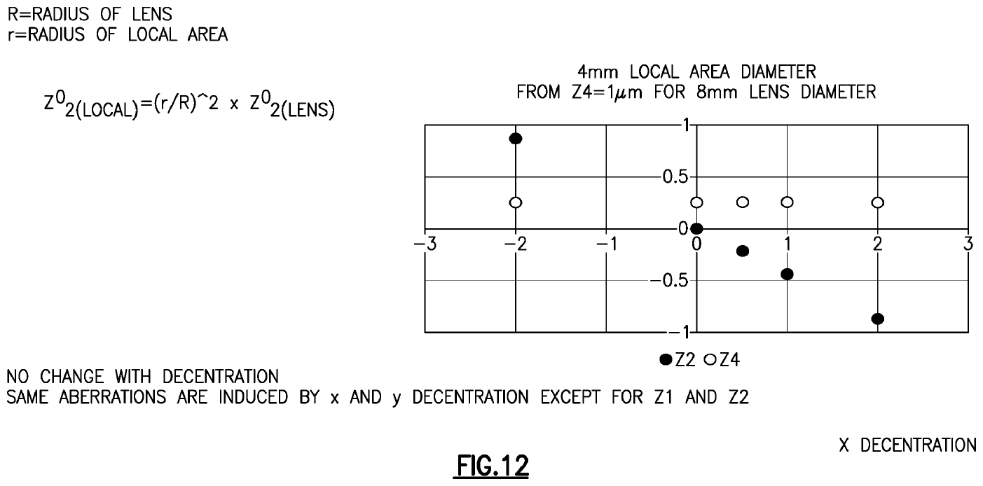

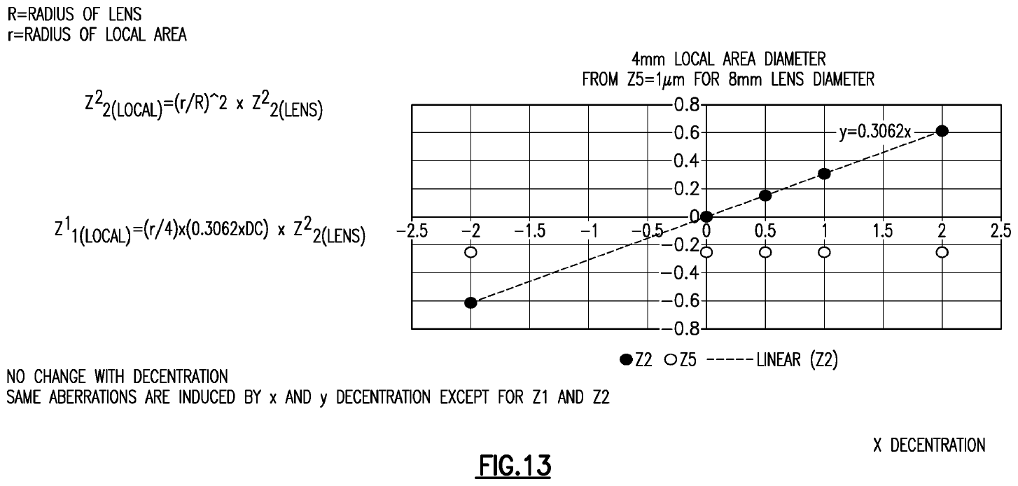

FIG. 11 is a drawing showing how aberrations can be induced in local areas of an exemplary contact lens. Note that the marked local areas include the translation of the view from the pupil plane to the contact lens plane.

Part 2—Induced Peripheral Aberrations (Astigmatism, Coma, and Spherical)

Part 2 describes a solution where a combination of astigmatism, coma, and spherical aberration can be added to the first or higher order myopia correction. The new structures correct previously uncorrected natural peripheral asymmetric aberrations. These new corrections are intended to make the point spread function (PSF) at the peripheral vision of the human eye radially symmetric for less blur anisotropy at the periphery of vision (i.e. at higher eccentricity). Moreover, the corrections to the peripheral aberrations optimally can be effective not just at the end of the peripheral vision towards a 30° eccentricity, but also at 20° eccentricity, including, in the case of the SCL, the overlap areas shown on FIG. 11.

FIG. 12 to FIG. 20 are graphs showing aberrations which can be induced on local areas of a corrective device, such as a contact lens according to the Application. For these plots, it is understood that there is a correction over the entire lens, e.g. a first or higher order myopia correction. Generally, the new approach is to provide additional corrections beyond the myopia correction to provide a radially symmetric blur in the peripheral vision.

The plots now show the new additional aberrations of the Application which can be induced in small areas towards and at the periphery of the lens. The x axis is in mm, where 2 mm is about a 30° eccentricity. These graphs show various suitable approaches to introduce the peripheral aberrations desired for the new method of the Application.

FIG. 12 is a drawing showing how defocus aberrations with X decentration can be induced in local areas of a lens. Z⁰_{2 (local)}=(r/R)\hat{ }2×Z⁰_{2 (lens)} where R is the radius of lens and r is the radius of local area. There was no change with decentration, and the same aberrations were induced by x and y decentration except for Z1 and Z2.

FIG. 13 is a drawing showing how vertical astigmatism aberrations with X decentration can be induced in local areas of a lens. Z²_{2 (local)}=(r/R)\hat{ }2×Z²_{2 (lens)}, Z¹_{1 (local)}=(r/4)×(0.3062×DC)×Z²_{2 (lens)} where R is the radius of lens and r is the radius of local area. There was no change with decentration, and the same aberrations were induced by x and y decentration except for Z1 and Z2.

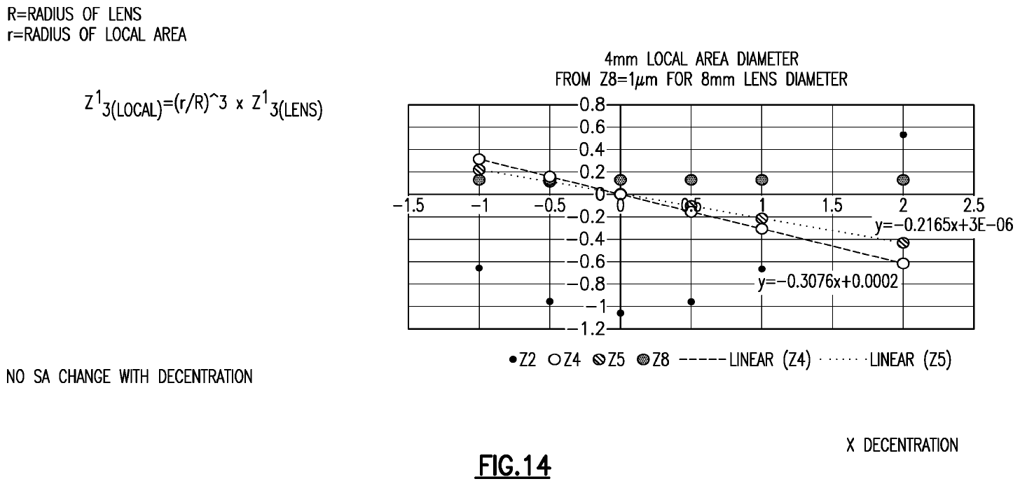

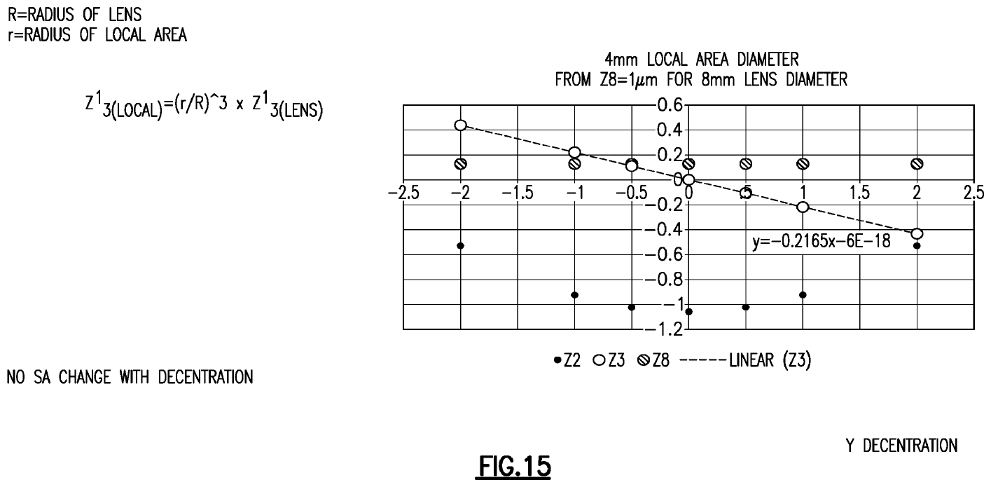

FIG. 14 is a drawing showing how horizontal coma aberrations with X decentration can be induced in local areas of a lens. Z¹_{3 (local)}=(r/R)\hat{ }3×Z¹_{3 (lens)} where R is the radius of lens and r is the radius of local area. There was no SA change with decentration. The graph shows the effect of adding the Z¹₃ aberration to a Z8 full lens correction.

FIG. 15 is a drawing showing how horizontal coma aberrations with Y decentration can be induced in local areas of a lens. Z¹_{3 (local)}=(r/R)\hat{ }3×Z¹_{3 (lens)} where R is the radius of lens and r is the radius of local area. There was no SA change with decentration.

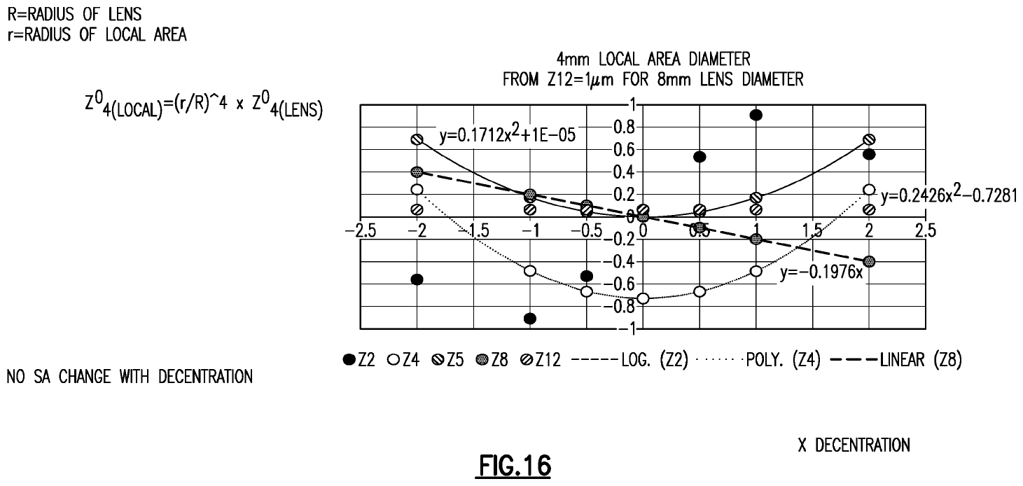

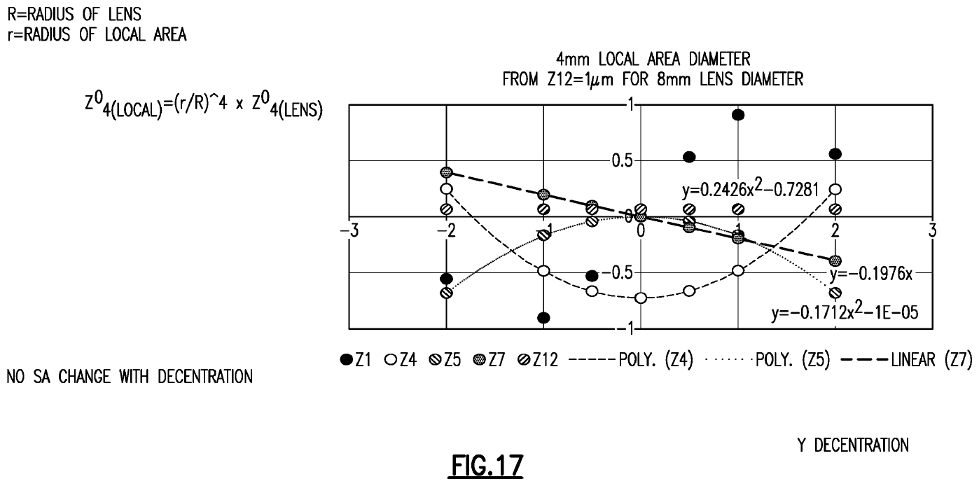

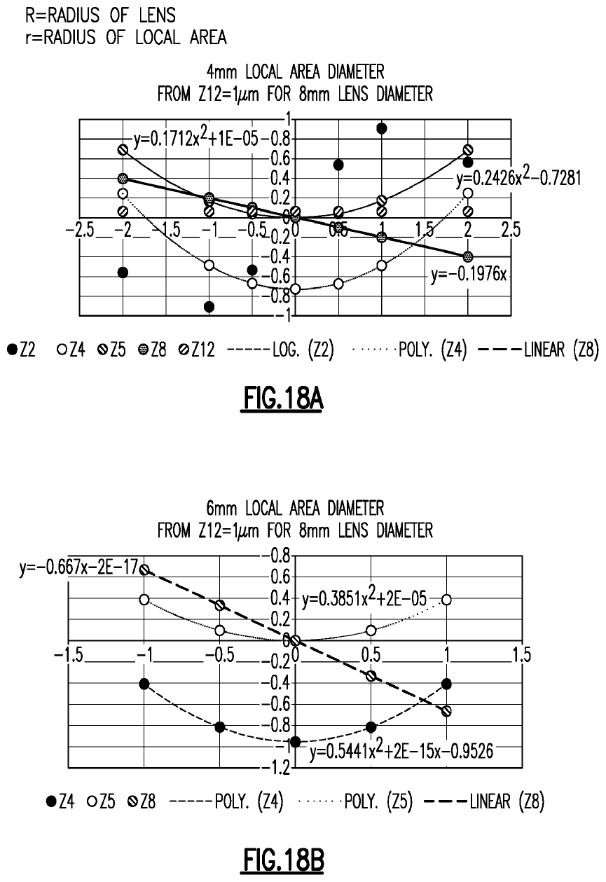

FIG. 16 is a drawing showing how spherical aberrations with X decentration can be induced in local areas of a lens. Z⁰_{4 (local)}=(r/R)\hat{ }4×Z⁰_{4 (lens)} where R is the radius of lens and r is the radius of local area. There was no SA change with decentration. Not the number of different types of aberrations induced by the Z⁰₄ spherical aberration, which include Z4, Z5, Z7, and Z12 (the underlying correction of FIG. 16).

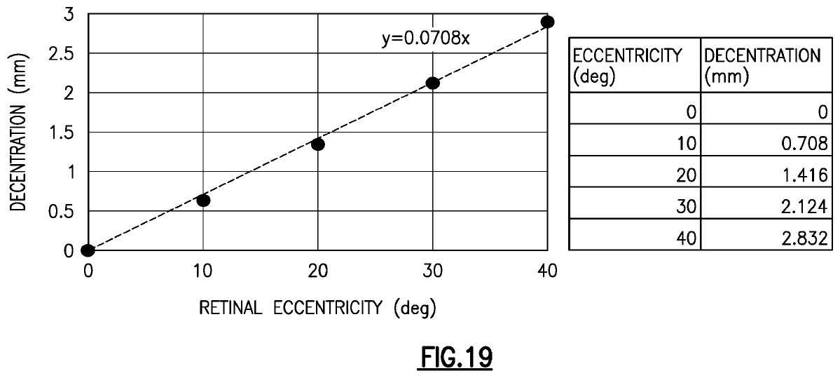

FIG. 17 is a drawing showing how spherical aberrations with Y decentration can be induced in local areas of a lens. Z⁰_{4 (local)}=(r/R)\hat{ }4×Z⁰_{4 (lens)} where R is the radius of lens and r is the radius of local area. There was no SA change with decentration.

FIG. 18A is a drawing showing how spherical aberrations with X decentration can be induced in a 4 mm local area of a lens.

FIG. 18B is a drawing showing how spherical aberrations with X decentration can be induced in a 6 mm local area of a lens.

Example: In modeling this exemplary lens, it was found that the peripheral blur anisotropy was significantly reduced to approach radial symmetry.

Aberrations Induced in Local Area of Lens include three different aberrations, defocus, astigmatism, and spherical aberration.

R is the radius of lens, r is the radius of local area, and DC is the decentration in mm

X-Decentration:

Z²_{2(local)}=Z⁰₄₍ₗₑₙₛ₎×(0.1712DC²)+(r/R)\hat{ }2×Z²₂₍ₗₑₙₛ₎

Z⁰_{2(local)}=Z⁰₄₍ₗₑₙₛ₎×(0.2426DC²−0.7281)+(r/R)\hat{ }2×Z¹_{3(local)}=Z⁰₄₍ₗₑₙₛ₎×(−0.1976DC)

Y-Decentration:

Z⁻²_{2(local)}=Z⁰₄₍ₗₑₙₛ₎×(−0.1712DC²)+(r/R)\hat{ }2×Z⁻²₂₍ₗₑₙₛ₎

Z⁰_{2(local)}=Z⁰₄₍ₗₑₙₛ₎×(−0.1712DC²)+(r/R)\hat{ }2×Z⁰₂₍ₗₑₙₛ₎

Z−¹_{3(local)}=Z⁰₄₍ₗₑₙₛ₎×(−0.1976DC)

FIG. 19 is a graph showing decentration of local area vs retinal eccentricity.

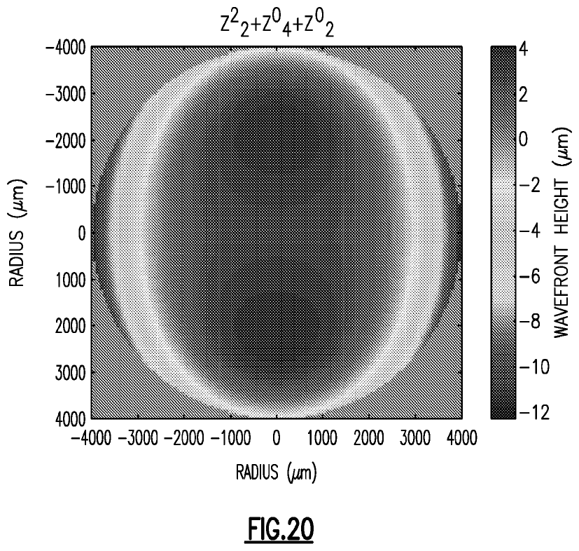

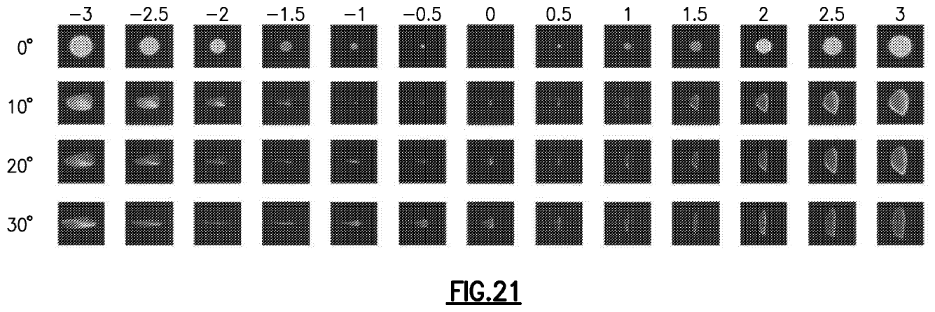

FIG. 20 is a plot showing an exemplary 8 mm diameter contact lens having the peripheral aberrations according to the example.

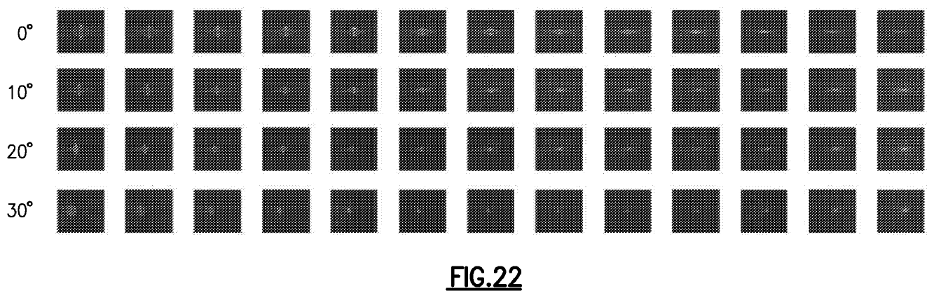

FIG. 21 is a series of images showing the point spread function without the lens. FIG. 22 is the same series point spread images with the exemplary lens. As can be seen in FIG. 22, there is a significantly improved radial symmetry at the periphery. However, the center line of sight vision is somewhat degraded. In some cases, a limited degradation of the central vision causes the by additional peripheral aberrations may be acceptable.

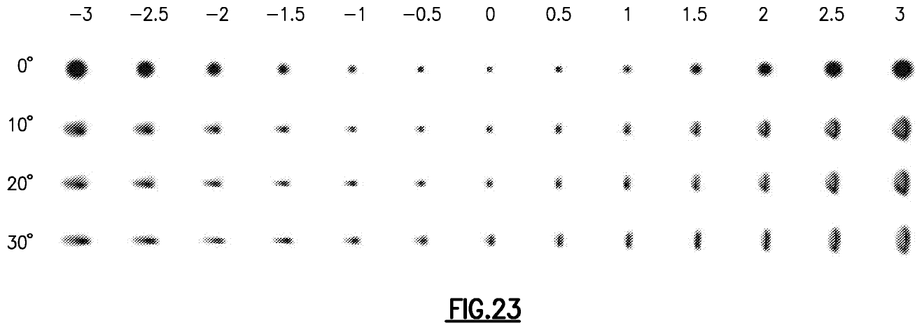

FIG. 23 and FIG. 24 show convolved images, where the point spread function charts of FIG. 21 and FIG. 22 are convolved with an “E” of a standard eye chart to show a corresponding predicted retinal image, i.e. what a person would see with and without the exemplary corrective lens. FIG. 23 shows convolved images without the lens. FIG. 24 shows the convolved images for the lens of FIG. 20.

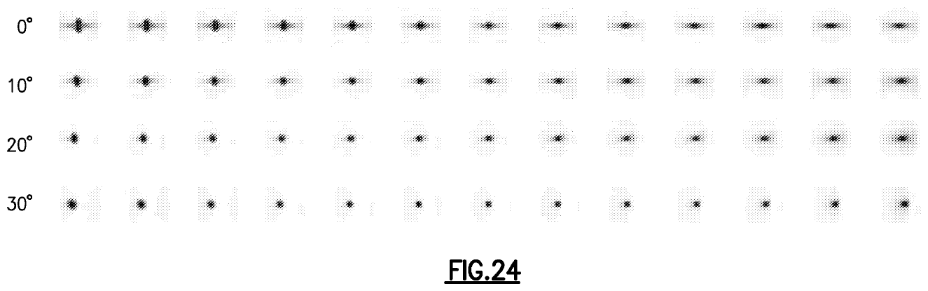

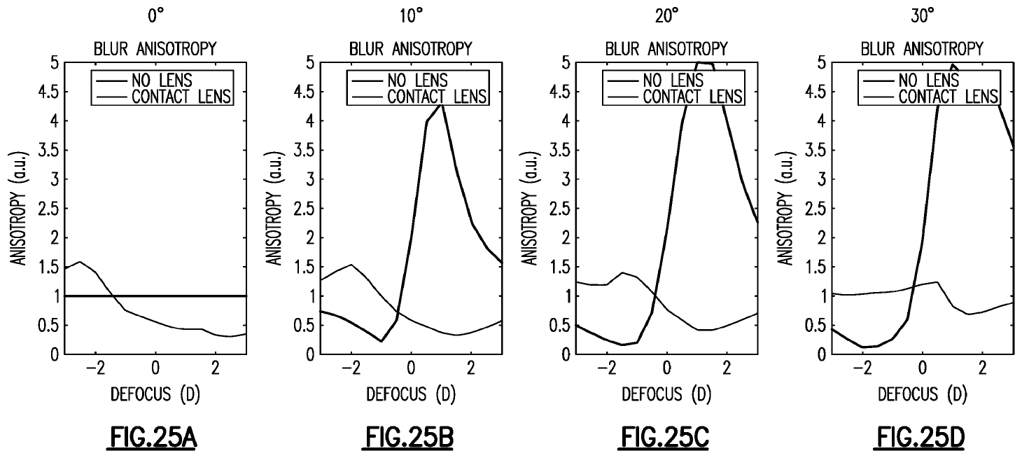

FIG. 25A to FIG. 25D show graphs of blur anisotropy with and without the exemplary lens with peripheral aberrations of FIG. 20 at four different eccentricities, 0°, 10°, 20°, and 30°. The unit of x-axis is in diopters (about −3 D to about +3 D). The Y-axis is unitless because it is the ratio between the vertical and horizontal blur components. A ratio of 1 indicates a perfect radially symmetrical blur. One goal of the design is to make the ratio closer to 1 (solid line) across retinal eccentricity. FIG. 25A shows a graphs of blur anisotropy with and without the exemplary lens of FIG. 20 at 0° eccentricity forward line of sight vision. FIG. 25B shows a graphs of blur anisotropy with and without the exemplary lens of FIG. 20 at a 10° eccentricity. FIG. 25C shows a graphs of blur anisotropy with and without the exemplary lens of FIG. 20 at a 20° eccentricity. FIG. 25D shows a graphs of blur anisotropy with and without the exemplary lens of FIG. 20 at a 30° eccentricity.

As can be seen by the exemplary lens with peripheral aberrations described hereinabove, introduction of the peripheral aberrations will typically undesirably distort the corrected forward vision. In some cases, the forward distortion may still be acceptable. However, what is needed is a more optimal solution which both introduced the desired peripheral aberrations yet minimized the undesired distortion of the forward line of sight vision at 0° eccentricity.

Part 3—Apodization of the Higher Order Peripheral Aberrations

Part 3 describes a solution to the problem of undesirable degradation of the first or higher order myopia correction by apodization of the higher order peripheral aberrations.

It was realized that the undesired aberrations of the central vision (forward line of sight) can be removed or substantially reduced, by multiplying the wavefront by an apodization function, such as an inverse super Gaussian apodization function. By so applying an envelope function to the peripheral aberrations by apodization that the undesired distortion of vision at about 0° eccentricity can be reduced and minimized as about flat.

For example, an inverse super Gaussian apodization function was modeled.

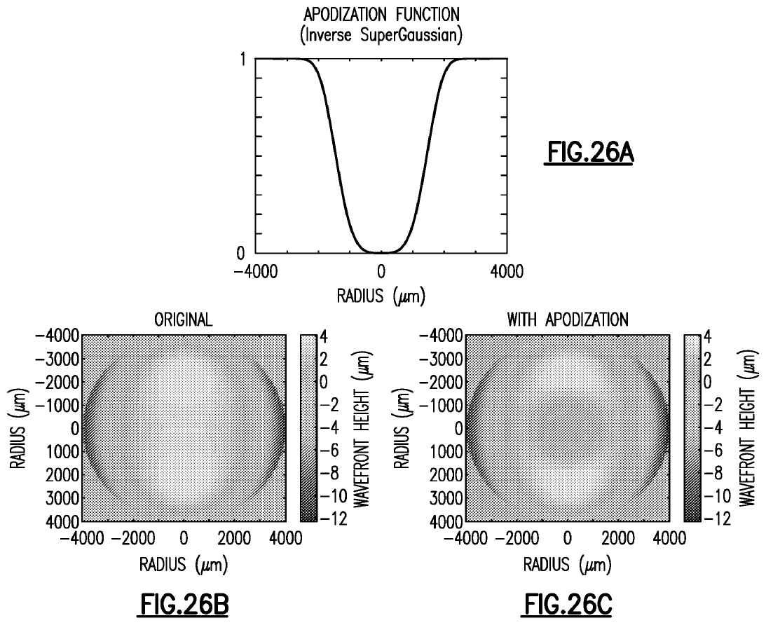

FIG. 26A is a graph showing an exemplary suitable super Gaussian apodization function. FIG. 26B is a plot showing a lens with peripheral aberrations as described hereinabove. FIG. 26C is a plot showing the lens of FIG. 26B with apodization using the exemplary function of FIG. 26A.

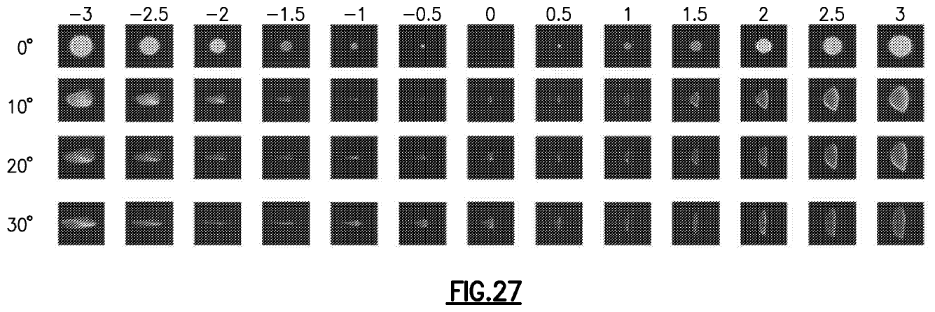

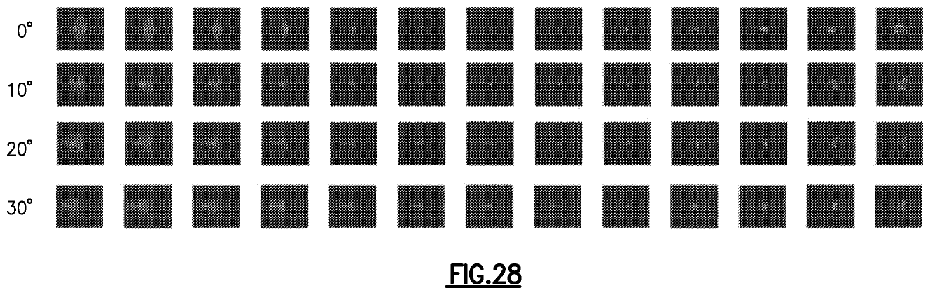

FIG. 27 is a series of images showing the point spread function without the lens of FIG. 26C. FIG. 28 is the same series point spread images with the exemplary lens of FIG. 26C. FIG. 29 and FIG. 30 show convolved images, where the point spread function charts of FIG. 27 and FIG. 28 are convolved with an “E” of a standard eye chart to show a corresponding predicted retinal image, i.e. what a person would see with and without the exemplary corrective lens. FIG. 29 shows convolved images without the lens. FIG. 30 shows the convolved images for the lens of FIG. 26C.

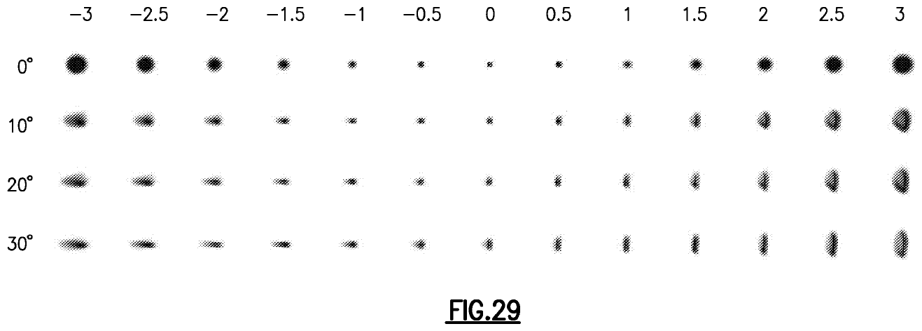

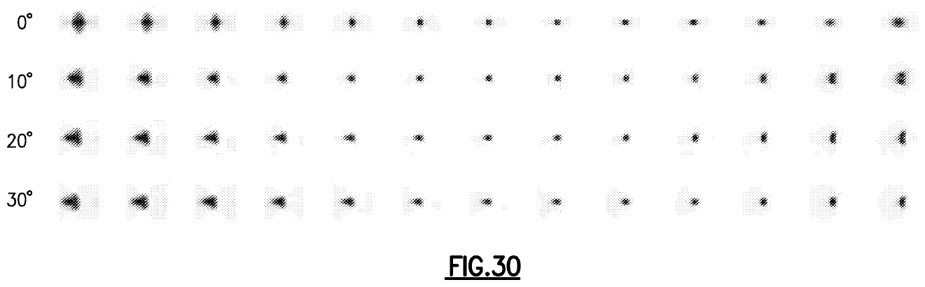

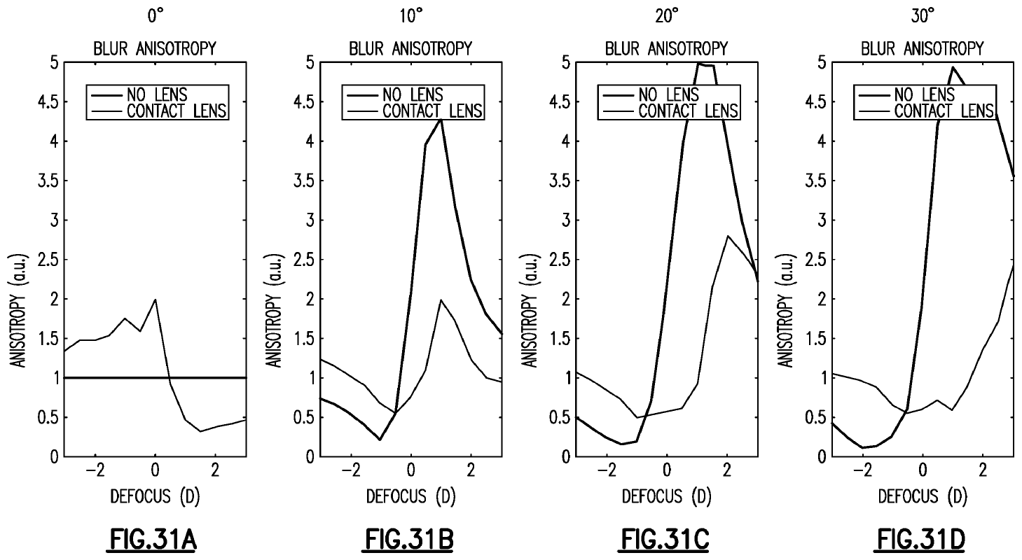

FIG. 31A to FIG. 31D show graphs of blur anisotropy with and without the exemplary lens with peripheral aberrations of FIG. 26C for a phase apodization where sigma is pupil/8. The unit of x-axis is in diopters (about −3 D to about +3 D). The Y-axis is unitless because it is the ratio between the vertical and horizontal blur components. A ratio of 1 indicates a perfect radially symmetrical blur. One goal of the design is to make the ratio closer to 1 (solid line) across retinal eccentricity. FIG. 31A shows a graphs of blur anisotropy with and without the exemplary lens of FIG. 26C at 0° eccentricity forward line of sight vision. FIG. 31B shows a graphs of blur anisotropy with and without the exemplary lens of FIG. 26C at a 10° eccentricity. FIG. 31C shows a graphs of blur anisotropy with and without the exemplary lens of FIG. 26C at a 20° eccentricity. FIG. 31D shows a graphs of blur anisotropy with and without the exemplary lens of FIG. 26C at a 30° eccentricity.

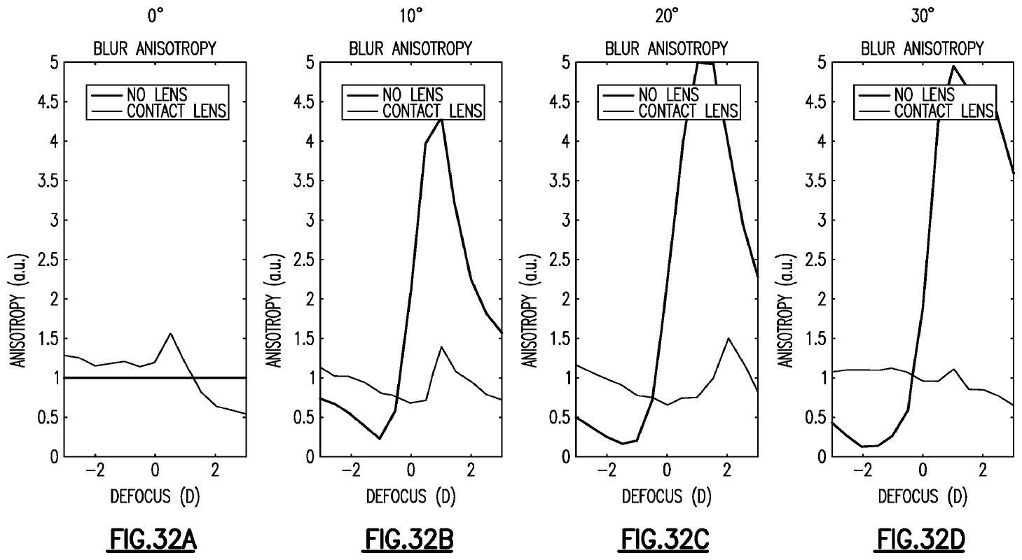

FIG. 32A to FIG. 32D show graphs of blur anisotropy with and without the exemplary lens with peripheral aberrations of FIG. 26C for a phase apodization where sigma is pupil/12. The unit of x-axis is in diopters (about −3 D to about +3 D). The Y-axis is unitless because it is the ratio between the vertical and horizontal blur components. A ratio of 1 indicates a perfect radially symmetrical blur. One goal of the design is to make the ratio closer to 1 (solid line) across retinal eccentricity. FIG. 32A shows a graphs of blur anisotropy with and without the exemplary lens of FIG. 26C at 0° eccentricity forward line of sight vision. FIG. 32B shows a graphs of blur anisotropy with and without the exemplary lens of FIG. 26C at a 10° eccentricity. FIG. 32C shows a graphs of blur anisotropy with and without the exemplary lens of FIG. 26C at a 20° eccentricity. FIG. 32D shows a graphs of blur anisotropy with and without the exemplary lens of FIG. 26C at a 30° eccentricity.

In summary, with apodization of the newly induced peripheral aberrations, the quality of the myopia correction for the central vision can be better maintained, while the desired peripheral aberrations of the Application provide blur symmetry at the periphery for the desired radial symmetry at the peripheral vision.

Any suitable corrective devices can be used to introduce the peripheral aberrations described hereinabove. Typically, such peripheral aberrations are introduced in combination with a first or higher order correction for Myopia. However, peripheral aberrations can be introduced in combination with no correction or any other types of vision correction.

Corrective devices according to the Application can be made based at least in part on actual measurements of the uncorrected peripheral aberrations of an individual patient. Here, a goal is to minimize the measured individual aberrations across the visual field. This is done by using the relationships between induced aberrations of a correction device with decentrations. Because it is not possible to come up with a design that perfectly satisfies all the visual fields, there can be an optimization process where each visual field is treated equally or weighted differently.

One metric useful to gauge an improvement of radial symmetry over the uncorrected peripheral vision is by the anisotropy ratio as described in more detail hereinabove, and as shown, for example, in FIGS. 25A-D, 31A-D and 32A-D (blur anisotropy analysis). In these exemplary graphs, the radial symmetry of the blur anisotropy as indicated by the anisotropy ratio (y-axis) has been improved from an uncorrected maximum of about 4.5 to 5 to a corrected maximum of about 2.5 to 2. Across the entire range of about −3 to 3 diopters (x-axis), blur anisotropy has been corrected to below about 2.5 and in some cases to about 1.

Suitable devices include contact lenses and particularly soft contact lenses similar to, but not limited the examples described hereinabove. Peripheral aberrations can also be introduced by conventional eyeglasses. Those skilled in the art will recognize that the distance from the pupil plane the plane of eyeglasses is larger than the much shorter distance between the pupil plane and a contact lens. In the opposite direction, moving closer to the pupil plane, the peripheral aberration described hereinabove, typically in combination with forward vision correction, can also be written directly on the cornea of the human eye.

Suitable devices to introduce the peripheral aberrations described hereinabove can be manufactured by any suitable materials by mechanical machining means, such as by use of lathes, milling machines (typically computer controlled numerical milling (CNC)), etc. Other suitable manufacturing techniques include laser manufacturing techniques. Exemplary suitable laser manufacturing and forming techniques include the Blue-IRIS, or blue intra-tissue refractive index shaping which have been described, for example, in U.S. Pat. No. 7,789,910 B2, OPTICAL MATERIAL AND METHOD FOR MODIFYING THE REFRACTIVE INDEX, to Knox, et. al.; U.S. Pat. No. 8,337,553 B2, OPTICAL MATERIAL AND METHOD FOR MODIFYING THE REFRACTIVE INDEX, to Knox, et. al.; U.S. Pat. No. 8,486,055 B2, METHOD FOR MODIFYING THE REFRACTIVE INDEX OF OCULAR TISSUES, to Knox, et. al.; U.S. Pat. No. 8,512,320 B1, METHOD FOR MODIFYING THE REFRACTIVE INDEX OF OCULAR TISSUES, to Knox, et. al.; and U.S. Pat. No. 8,617,147 B2, METHOD FOR MODIFYING THE REFRACTIVE INDEX OF OCULAR TISSUES. All of the above named patents, including the '910, '553, '055, '320, and '147 patents are incorporated herein by reference in their entirety for all purposes.

Suitable materials include any suitable plastic, glass, including any suitable contact lens materials.

Suitable devices for myopia correction combined with the new plurality of additional peripheral aberrations as described by the Application hereinabove include, for example, contact lenses, including soft contact lenses (SCL), hard contact lenses, eyeglasses, and surgical interventions, including writing lenses directly on the cornea of the eye. Hard contact lenses as used in the Application, include, for example, rigid gas permeable, scleral lens (small and large diameter), and orthokeratology.

Software for modeling and creating the structures (e.g. lens patterns to be written by laser or milled by machines) for writing or machining the peripheral aberrations described hereinabove to optical devices (e.g. eyeglass lenses, contact lenses, the cornea of the human eye) can be provided on a computer readable non-transitory storage medium. A computer readable non-transitory storage medium as non-transitory data storage includes any data stored on any suitable media in a non-fleeting manner Such data storage includes any suitable computer readable non-transitory storage medium, including, but not limited to hard drives, non-volatile RAM, SSD devices, CDs, DVDs, etc.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A vision corrective lens for myopia control comprising:
a myopia correction applied across said vision corrective lens; and
a plurality of additional peripheral aberrations applied at more than about 20° eccentricity comprising at least an astigmatism correction, a defocus correction, and a spherical aberration correction, the combination of said plurality of additional peripheral aberrations to cause a radially symmetric blur pattern of a peripheral vision.

2. The vision corrective lens of claim 1, wherein said plurality of additional peripheral aberrations are corrections based at least in part on a measurement of at least one of: a peripheral astigmatism aberration, a peripheral defocus aberration, or a peripheral spherical aberration of an uncorrected eye.

3. The vision corrective lens of claim 1, wherein an apodization function is applied to said additional plurality of peripheral aberrations to reduce undesired changes to said myopia correction for a forward line of sight central vision at an eccentricity of about 10° or less.

4. The vision corrective lens of claim 3, wherein said apodization function comprise a gaussian apodization function.

5. The vision corrective lens of claim 1, wherein said vision corrective lens comprises a soft contact lens.

6. The vision corrective lens of claim 1, wherein said vision corrective lens comprises a hard contact lens.

7. The vision corrective lens of claim 1, wherein said vision corrective lens comprises a lens of eyeglasses.

8. The vision corrective lens of claim 1, wherein said vision corrective lens comprises a lens written through a surgical technique onto a cornea of an eye.

9. A method to fabricate a myopia control device comprising:
determining a myopia correction;
determining a plurality of additional peripheral aberrations applied at more than about 20° eccentricity comprising at least an astigmatism correction, a defocus correction, and a spherical aberration correction, the combination of said plurality of additional peripheral aberrations to cause a radial symmetric blur pattern of a peripheral vision;
combining said myopia correction and said plurality of additional peripheral aberrations; and
forming said myopia control device with a combination of said myopia correction and said plurality of additional peripheral aberrations onto a surface of a corrective lens.

10. The method of claim 9, further comprising after said step of determining said plurality of additional peripheral aberrations, applying an apodization function to said plurality of additional peripheral aberrations to provide an apodized plurality of said additional peripheral aberrations, and wherein said step of combining said myopia correction and said plurality of additional peripheral aberrations comprises combining said myopia correction and said apodized plurality of said additional peripheral aberrations.

11. The method of claim 9, wherein said step of forming comprises forming said myopia control device onto said surface of said corrective lens by a machining technique.

12. The method of claim 9, wherein said step of forming comprises forming said myopia control device onto said surface of said corrective lens by a laser technique.

13. The method of claim 9, wherein said step of forming comprises forming said myopia control device onto said surface of a soft contact lens.

14. The method of claim 9, wherein said step of forming comprises forming said myopia control device onto said surface of a hard contact lens.

15. The method of claim 9, wherein said step of forming comprises forming said myopia control device onto said surface of a lens of eyeglasses.

16. The method of claim 9, wherein said step of forming comprises surgically forming said myopia control device onto said surface of a cornea of an eye.

17. A method to specify optical parameters of a myopia control device comprising:
determining a myopia correction; and
adding a plurality of additional peripheral aberrations applied at more than about 20° eccentricity comprising at least an astigmatism correction, a defocus correction, and a spherical aberration correction, the combination of said plurality of additional peripheral aberrations to cause a radial symmetric blur pattern of a peripheral vision.
